(19) United States
(12) Patent Application Publication
(10) Pub. No.: US 2014/0278611 A1
(43) Pub. Date: Sep. 18, 2014

(54) RESTAURANT MANAGEMENT

(71) Applicants: Charles Russell, McKinney, TX (US); Tanya Endicott, Allen, TX (US)

(72) Inventors: Charles Russell, McKinney, TX (US); Tanya Endicott, Allen, TX (US)

(21) Appl. No.: 14/214,459

(22) Filed: Mar. 14, 2014

Related U.S. Application Data
(60) Provisional application No. 61/851,936, filed on Mar. 14, 2013.

(51) Int. Cl. G06Q 50/12; G06Q 10/06

(52) U.S. Cl. CPC G06Q 50/12; G06Q 10/063114
USPC 705/5; 705/7.15

(57) ABSTRACT

The invention provides systems, methods and devices for automated restaurant management. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 CFR 1.72(b).

### CLAIM OF PRIORITY

The invention is related to and claims priority from U.S. Provisional Patent Application No. 61/851,936 to Russell, et al entitled RESTAURANT MANAGEMENT and filed on Mar. 14, 2013.

### FIELD OF INVENTION

The invention relates generally to restaurant management, and more particularly to systems, methods and devices for managing wait staff and customer experiences.

### PROBLEM STATEMENT

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### Discussion

Better restaurant management leads to better customer experiences. However, dine-in restaurants wait for customers to arrive before preparing orders, and often deliver a customer's check at an awkward time. In short, customer experience at restaurants could be vastly improved. The present invention solves these and other problems associated with managing customer experiences at restaurants.

### BRIEF DESCRIPTION OF THE DRAWINGS AND TABLES

Various aspects of the invention, as well as an embodiment, are better understood by reference to the following detailed description. To better understand the invention, the detailed description should be read in conjunction with the drawings and tables, in which:

FIG. 1 is a block-diagram of a restaurant using a restaurant management system according to the invention.

FIG. 2 illustrates a customer engagement algorithm according to the invention.

FIG. 3 illustrates a waiter engagement algorithm according to the invention.

FIG. 4 illustrates a restaurant management algorithm according to the invention.

### EXEMPLARY EMBODIMENT OF A BEST MODE

### Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning—” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

As will be understood by those of ordinary skill in the art, various structures and devices are depicted in block diagram form in order to avoid unnecessarily obscuring the invention. It should be noted in the following discussion that acts with like names are performed in like manners, unless otherwise stated.

Of course, the foregoing discussions and definitions are provided for clarification purposes and are not limiting. Words and phrases are to be given their ordinary plain meaning unless indicated otherwise.

### Description of the Drawings

FIG. 1 is a block-diagram of a restaurant using a restaurant management system 100 according to the invention. Illustrated in FIG. 1 is a smart phone 110 which could be any mobile computing device, such as smart phones, cell phones, smart pads, or smart watches, for example. The smart phone 110 is used by a restaurant customer to interact with the restaurant management system; and, one way to implement this functionality is via a web or mobile “App” (or software Application). Also provided in FIG. 1 is a cloud/network 120, which is an abstraction of remote computing including remote memory (such as a remote server 130), as well as wireless networks, such as cell-phone and satellite networks. Communications between the smart phone 110 a first waiter smart phone 112 used by a first waiter 160, and a local computer 150 are illustrated via “lightning”, however, such communications could be via wireless or wire-line communications, including via a wireless LAN at the restaurant 140. Shown in the restaurant 140 are a plurality of tables 142, 144, 146 and 148.

FIG. 2 illustrates a customer engagement algorithm 200 according to the invention, and with simultaneous reference to FIG. 1. The customer engagement algorithm 200 begins with a restaurant selection act 210, in which a customer chooses which restaurant they wish to visit. The selection of the restaurant may be made by the customer directly typing/speaking the name of the restaurant they want to visit, by selecting the restaurant from a menu of restaurants that participate with a restaurant management system according to the invention, or by selecting the restaurant from a map-view of participating restaurants. Next, the algorithm 200 proceeds to a table assignment act 220. In the table assignment act 210 the customer is associated with a table in the restaurant 140, such as tables 142-148. This may be accomplished by an algorithm which, in one embodiment, determines which table/waiter combination will deliver a predicted best service to that customer at their time of arrival. In another embodiment, the table assignment act 210 is accomplished via an administrator, such as the waiter 160, making the table assignment. Then, in a waiter assignment act 230 a waiter is assigned to the customer as well as the table that is associated with the customer.

Following the assignment of a waiter with a table and the customer, the algorithm 200 proceeds to a first restaurant interaction act 240, in which the restaurant management system receives, preferably at the server 150, a customer request or input. Examples of restaurant interactions include placing an order, requesting assistance from a waiter to place an order, requesting a drink, requesting a drink refill, requesting condiments, requesting utensils, closing out the bill, requesting a tip amount, or splitting the bill, for example. Then, in a waiter interactions act 250, a waiter respond to the request made in the restaurant interactions act 240. As a waiter fulfills the request, the waiter, the customer, a manager or automation indicates that the request has been fulfilled. Then, in a payment act 260, the customer pays for the meal. Although the payment act 260 may trigger the restaurant management system to bus the table, in an alternative embodiment geolocation/geofencing features may be used to alert the busing of the table when the customer leaves the restaurant.

FIG. 3 illustrates a waiter engagement algorithm 300 according to the invention. Initially, in a customer assignment act 310, a waiter is notified that they have been assigned to a customer and/or a table. This allows a greeter, the waiter or team of waiters to greet the customer(s) at the table. Next, in a customer request act 320, the waiter receives a customer request that a waiter can address. Examples of customer requests include requesting assistance from a waiter to place an order, requesting a drink, requesting a drink refill, requesting condiments, requesting utensils, requesting a tip amount, or requesting help with the bill, for example. In one embodiment, the waiter fulfilling the request inputs that they have addressed the request. Then, in a payment notification act 330, the waiter (and in one embodiment, the bus staff) is notified that the customer has paid.

FIG. 4 illustrates a restaurant management algorithm 400 according to the invention. The restaurant management algorithm 400 in one embodiment executes on a computer, such as the local computer 150. Accordingly, in one embodiment the algorithm executes as a computer-implemented method for managing a restaurant-customer interaction. The algorithm 400 starts with a receive customer log-in act 410 in which a restaurant management system receives a notification that a customer intends to visit the restaurant and place an order. In one embodiment the algorithm 400 ask the user for reservation information, such as name, address, loyalty card number, or credit card information, for example. Next, when the customer arrives at the restaurant, the algorithm 400 receives a notice that the customer has arrived at the restaurant, associates the customer with a table, and associates the customer with at least a first waiter, which may include a team of waiters. The waiter/customer association may be accomplished via machine intelligence embedded within the restaurant management system, or made via a human interaction, such as via a waiter, greeter, or administrator. Further, the restaurant management system may direct the customer to the appropriate table. Then, in one embodiment, a picture of the waiter may be pushed to the customer to facilitate the customer experience.

Next, in a receive customer notification act 420 the algorithm 400 is notified that a customer has made a request such as a service request, or made another interaction with the restaurant management system. Next, in a receive server(s) response act 430, the restaurant management system logs a waiter response, where the waiter response comprises a waiter responding to the service request. Next, in a new notification query 440, the algorithm 400 waits on a customer to initiate another customer notification. If a new customer notification is received, then the algorithm proceeds along the “Y” decision path to return to the receive customer notification act 420. In the event a new customer notification is not received, the algorithm proceeds along the “N” decision path to a receive/log payment act 450, which the restaurant management system receives notification that a payment for the order has been received.

The algorithm 400 next proceeds to a data to analytics act 460 in which data associated with the customer visit, defined as an event, is loaded into the restaurant management system and, in one embodiment, analytics are conducted in real time by an analytics engine. Analytics may, for example, calculate: the average time it took a waiter to respond to a customer notification for an event, logging the service requests by a request type for an event, the average time it took a particular waiter to respond to at least a first customer notification, the average time it took a particular waiter to respond to customer notifications and comparing the average time for the waiter to the average time for all waiters. Further, analytics may be generated for a specific shift. For example, the system may calculate for all waiters in a shift, an average time it took to respond to customer notifications during that shift, and comparing it to the same event data for at least one other shift.

Additionally, the restaurant management system may implement quality control measures. For example, the algorithm 400 may send a request to the customer to verify that the recorded time to respond to the requests is accurate. Additionally, the methodology may be implemented via means for implementing each of the described functionalities in means known and foreseeable in the computing arts.

Thus, though the invention has been described with respect to a specific preferred embodiment, many advantages, variations and modifications will become apparent to those skilled in the art upon reading the present application. It is therefore the intention that the appended claims and their functional equivalents be interpreted as broadly as possible in view of the prior art to include all such variations and modifications.

What is claimed is:

1. A computer-implemented method for managing a restaurant-customer interaction, comprising:
at a restaurant associated with a restaurant management system, receiving a notification that a customer intends to visit the restaurant and place an order;
receiving a notice that the customer has arrived at the restaurant;
associating the customer with a table;
associating the customer with at least a first waiter;
receiving a customer notification, where the customer notification comprises the customer using the restaurant management system to make a service request;
logging a waiter response, where the waiter response comprises a waiter responding to the service request; and
receiving a payment for the order.

2. The computer-implemented method of claim 1 further comprising accepting a customer reservation.

3. The computer-implemented method of claim 1 further comprising directing the customer to the table associated with the customer.

4. The computer-implemented method of claim 1 further comprising pushing a picture of the at least a first waiter to the customer.

5. The computer-implemented method of claim 1 wherein the customer notification comprises receiving an order for a meal directly from the customer without a waiter interaction.

6. The computer-implemented method of claim 1 wherein the customer notification comprises receiving a request for a waiter to assist with placing an order.

7. The computer-implemented method of claim 1 wherein associating the customer with at least a first waiter associates the customer with a team of waiters.

8. The computer-implemented method of claim 1 further comprising defining the data associated with the restaurant-customer interaction as an event data, and sending the event to an analytics engine.

9. The computer-implemented method of claim 8 further comprising calculating, for an event, the average time it took a waiter to respond to a customer notification.

10. The computer-implemented method of claim 8 further comprising calculating, for an event, logging the service requests by a request type.

11. The computer-implemented method of claim 8 further comprising calculating, for a waiter, the average time it took the waiter to respond to at least a first customer notification.

12. The computer-implemented method of claim 8 further comprising calculating, for a waiter, the average time it took the waiter to respond to customer notifications, and comparing the average time for the waiter to the average time for all waiters.

13. The computer-implemented method of claim 1 further comprising sending a request to the customer to verify that the recorded time to respond to the requests is accurate.

14. The computer-implemented method of claim 8 further comprising calculating, for all waiters in a shift, an average time it took to respond to customer notifications during that shift, and comparing it to the same event data for at least one other shift.

15. A computer-implemented method for managing a restaurant-customer interaction, comprising:
at a restaurant associated with a restaurant management system, a means for receiving a notification that a customer intends to visit the restaurant and place an order;
means for receiving a notice that the customer has arrived at the restaurant;
means for associating the customer with a table;
means for associating the customer with at least a first waiter;
means for receiving a customer notification, where the customer notification comprises the customer using the restaurant management system to make a service request;
means for logging a waiter response, where the waiter response comprises a waiter responding to the service request; and
means for receiving a payment for the order.
